(19) United States
(12) Patent Application Publication
(10) Pub. No.: US 2006/0037425 A1
(43) Pub. Date: Feb. 23, 2006

(54) Shaft assembly for use in steering systems

(75) Inventors: Garrett R. Kolo, Lafayette, IN (US); John A. Budzik, Lafayette, IN (US); Tony L. Stevens, Lafayette, IN (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive U.S. LLC

(21) Appl. No.: 10/919,581

(22) Filed: Aug. 17, 2004

(51) Int. Cl. B62D 1/18

(52) U.S. Cl. 74/493

(57) ABSTRACT

An apparatus (40) for transmitting force between a steering wheel (28) and a steering gear (26) that is operable to turn steerable wheels (14) of a vehicle (10). The apparatus (40) includes a shaft assembly (42) including a pair of telescoping shaft portions (52, 54) rotatable about a common axis (56) to effect vehicle steering. A bearing (60) that supports at least one of the shaft portions (52, 54) for rotation about the common axis (56). A support (244) for the bearing (260) is breakable when the shaft portions (52, 54) are blocked from telescoping movement. A containment structure (280) permits limited movement of the shaft portions (52, 54) transverse to the common axis (56) in the event that the support (244) breaks.

### FIELD OF THE INVENTION

The present invention relates to an apparatus for use in transmitting force between a steering wheel that is disposed in a passenger compartment of a vehicle and a steering gear operable to turn steerable wheels of the vehicle.

### BACKGROUND OF THE INVENTION

It is known to provide an apparatus for transmitting force between a steering gear that is mounted on the frame of a vehicle and a steering wheel that is disposed in a passenger compartment of the vehicle. The known apparatuses include a shaft assembly that is connected to the steering wheel and the steering gear by universal joints at opposite ends of the shaft assembly. The length of the shaft assembly may be variable to accommodate relative movement between steering gear and the steering wheel.

In a vehicle having a shaft assembly with the known construction, one end of the shaft assembly is connected to the steering gear, which is mounted on the frame of the vehicle. The opposite end of the shaft assembly is operatively connected to the steering wheel of the vehicle, for example, via a steering column. The shaft assembly may include telescoping shafts that permit relative movement between the portion of the shaft assembly connected to the steering gear and the portion of the shaft assembly connected to the steering wheel.

### SUMMARY OF THE INVENTION

The present invention relates to an apparatus for transmitting force between a steering wheel and a steering gear that is operable to turn steerable wheels of a vehicle. The apparatus includes a shaft assembly including a pair of telescoping shaft portions rotatable about a common axis to effect vehicle steering. A bearing supports at least one of the shaft portions for rotation about the common axis. A support for the bearing is breakable when the shaft portions are blocked from telescoping movement. A containment structure permits limited movement of the shaft portions transverse to the common axis in the event that the support breaks.

The present invention also relates to an apparatus for transmitting force between a steering wheel and a steering gear that is operable to turn steerable wheels of a vehicle. The apparatus includes a shaft assembly comprising a first shaft portion having a telescoping length and a second shaft portion having a telescoping length. The first and second shaft portions each have a longitudinal axis. The shaft assembly has a first end operatively connected to the steering gear and an opposite second end operatively connected to the steering wheel. A bearing assembly, connected to a portion of the vehicle, supports the first shaft portion for rotation about its longitudinal axis. A containment structure limits movement of the longitudinal axis of the first shaft portion relative to the portion of the vehicle upon breakage of the bearing assembly.

### BRIEF DESCRIPTION OF THE DRAWINGS

The foregoing and other features of the present invention will become apparent to one skilled in the art to which the present invention relates upon consideration 5 of the following description of the invention with reference to the accompanying drawings, in which:

FIG. 1 is a schematic illustration of a vehicle having a variable length shaft assembly through which force is transmitted between a steering wheel and a steering gear;

FIG. 2 is an enlarged perspective illustration of the variable length shaft assembly of FIG. 1; and

FIGS. 3A-3C are schematic illustrations of the variable length shaft assembly of FIG. 2 illustrating the shaft assembly in different conditions.

### DESCRIPTION OF AN EMBODIMENT

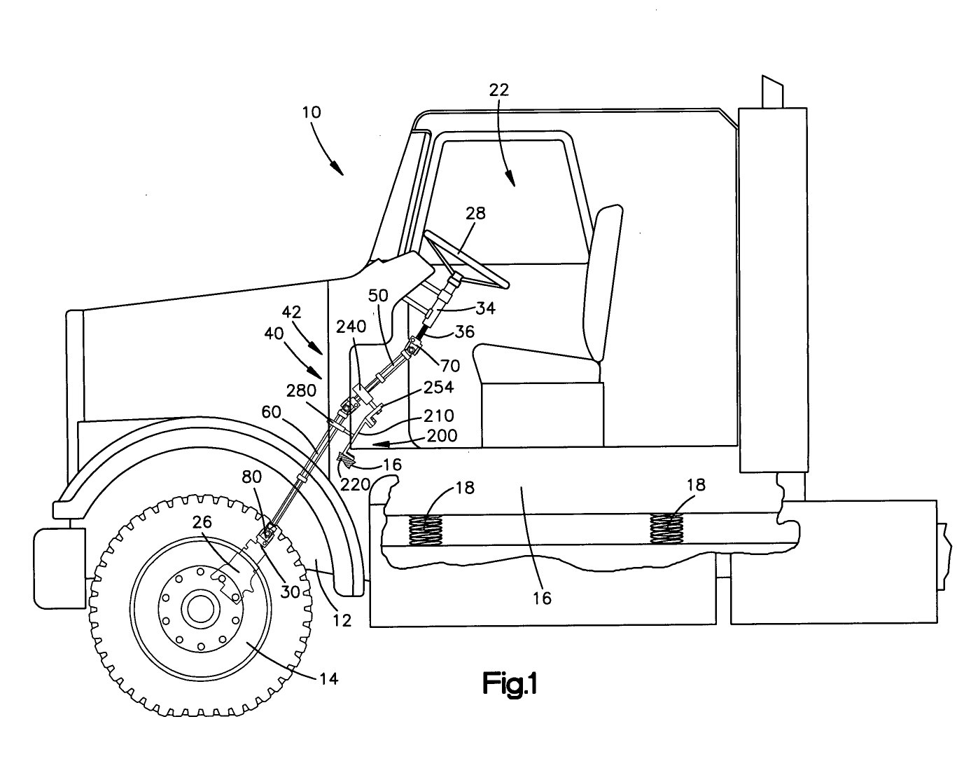

Referring to FIG. 1, a vehicle 10 includes a frame 12 that is partially supported by steerable vehicle wheels 14. A body 16 is connected to the frame 12 by resilient connections 18 that are indicated schematically in FIG. 1. The resilient connections 18 enable the body 16 of the vehicle 10 to move relative to the frame 12 during operation of the vehicle. The resilient connections 18 help isolate a passenger compartment 22 in the body 16 of the vehicle 10 from vibration during operation of the vehicle.

In response to rotation of a steering wheel 28 in the passenger compartment 22, the vehicle wheels 14 are turned or steered via steering gear 26 mounted on the frame 12. The steering gear 26 may have any construction suitable to effect turning or steering movement of the vehicle wheels 14 in response to a force imparted to an input shaft 30 via rotation of the steering wheel 28.

The steering wheel 28 is rotatably supported in the passenger compartment 22 by a steering column 34. In the illustrated embodiment of the invention, the steering column 34 is fixedly connected to the body 16 of the vehicle 10. Therefore, the steering column 34 supports the steering wheel 28 in a predetermined position in the passenger compartment 22. The steering column 34 has a rotatable output shaft 36.

The steering column 34 may have any construction suitable to support the steering wheel 28 for rotation. The steering column could, however, have alternative constructions, such as a tilt construction, a telescopic construction, or both.

According to the present invention, an apparatus 40 for transmitting force between the steering wheel 28 and the steering gear 26 comprises a steering shaft assembly 42. The shaft assembly 42 is rotatable to transmit rotational force from the steering wheel 28 to the steering gear 26 upon rotation of the steering wheel. The rotational force transmitted through the shaft assembly 42 effects turning or steering movement of the steerable wheels 14 via actuation of the steering gear 26.

The shaft assembly 42 includes a variable length, telescopic first or upper shaft portion 50 and a variable length, telescopic second or lower shaft portion 60. The upper shaft portion 50 and the lower shaft portion 60 help accommodate relative movement between the steering gear 26, frame 12, and body 16 of the vehicle 10. This is described in further detail below.

A first or upper universal joint 70 interconnects an end of the upper shaft portion 50 of the shaft assembly 42 with the output shaft 36 of the steering column 34. A second or lower universal joint 80 interconnects an end of the lower shaft portion 60 of the shaft assembly 42 with the input shaft 30 of the steering gear 26. A third or middle universal joint 90 interconnects an end of the upper shaft portion 50 opposite the steering column 34 with an end of the lower shaft portion 60 opposite the steering gear 26.

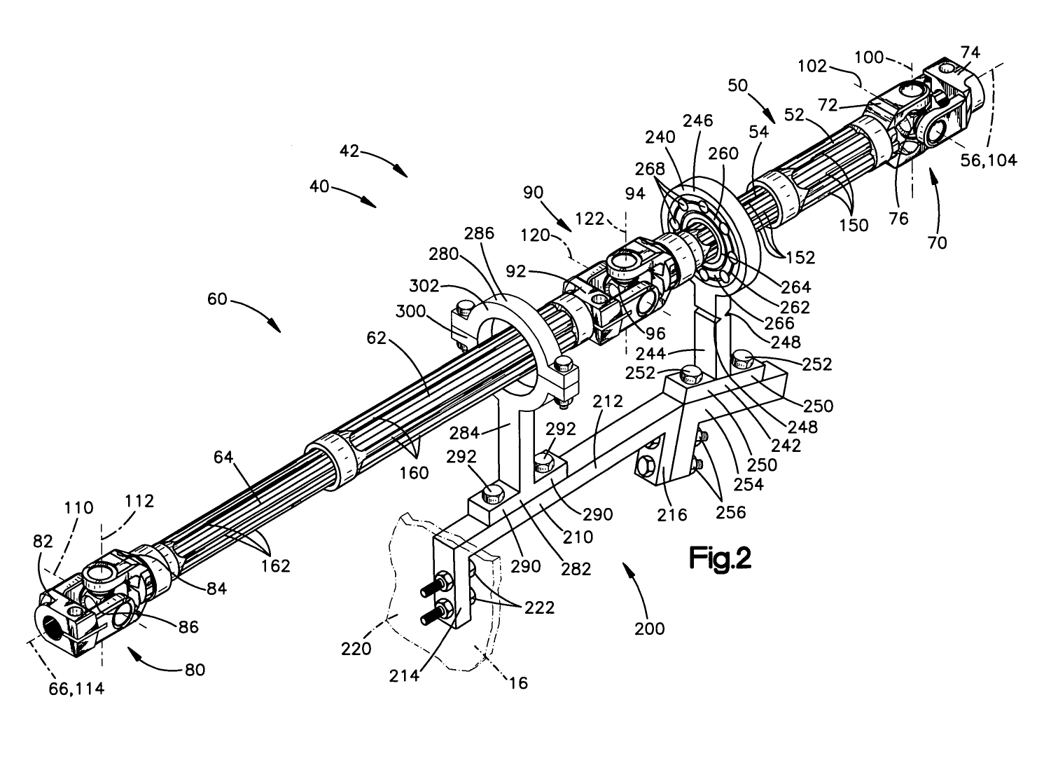

Referring to FIG. 2, the upper shaft portion 50 of the shaft assembly 42 includes a generally tubular first portion 52 and a second portion 54. The first and second portions 52 and 54 are configured and arranged coaxially along an axis 56 such that a portion of the length of the second portion is positioned within the axially extending interior space defined by the first portion. The first and second portions 52 and 54 are also configured and arranged such that the first and second portions are movable relative to each other along the axis 56. This gives the upper shaft portion 50 of the shaft assembly 42 a variable length, telescoping configuration. The telescoping movement between the first and second portions 52 and 54 of the upper shaft portion 50 may be dampened by means (not shown), such as a spring or fluid dampener.

The lower shaft portion 60 of the shaft assembly 42 includes a generally tubular first portion 62 and a second portion 64. The first and second portions 62 and 64 are configured and arranged coaxially along an axis 66 such that a portion of the length of the second portion is positioned within the axially extending interior space defined by the first portion. The first and second portions 62 and 64 are also configured and arranged such that the first and second portions are movable relative to each other along the axis 56. This gives the upper shaft portion 50 of the shaft assembly 42 a variable length, telescoping configuration. The telescoping movement between the first and second portions 62 and 64 of the lower shaft portion 60 may be dampened by means (not shown), such as a spring or fluid dampener.

The first portion 52 of the upper shaft portion 50 is connected to the output shaft 36 (see FIG. 1) of the steering column 34 via the upper universal joint 70. The first portion 62 of the lower shaft portion 60 is connected to the input shaft 30 (see FIG. 1) of the steering gear 26 via the lower universal joint 80. The second portion 54 of the upper shaft portion 50 is connected to the first portion 62 of the lower shaft portion 60 via the middle universal joint 90. The upper and lower shaft portions 50 and 60 are rotatable with each other about their respective axes 56 and 66. The middle universal joint 90 permits the upper and lower shaft portions 50 and 60 to be arranged with their respective axes 56 and 66 extending coaxially or at an angle with each other while maintaining their ability to rotate with each other.

Referring to FIG. 2, the upper universal joint 70 includes an output yoke member 72 that is fixedly connected to a terminal end of the upper shaft portion 50 of the shaft assembly 42, on an end of the first portion 52. The upper universal joint 70 also includes an input yoke member 74 that is fixedly connected to the output shaft 36 of the steering column 34 (see FIG. 1). The upper universal joint further includes a right angle cross member 76 that is connected to the output yoke member 72 and the input yoke member 74.

The cross member 76 enables pivotal movement to occur about orthogonal axes 100 and 102. The output yoke member 72 and the cross member 76 are pivotal relative to each other about the axis 100. The input yoke member 74 and the cross member 76 are pivotal relative to each other about the axis 102. The axis 102 extends perpendicular to the axis 100 and to an axis 104 about which the input yoke member 74 and the output shaft 36 (see FIG. 1) of the steering column 34 is rotatable. The axis 104 is fixed relative to the body 16 of the vehicle 10. The axis 100 extends perpendicular to the axis 56 about which the upper shaft portion 50 of the shaft assembly 42 is rotatable.

The lower universal joint 80 includes an output yoke member 82 that is fixedly connected to the input shaft 30 of the steering gear 26 (see FIG. 1). The lower universal joint 80 also includes an input yoke member 84 that is connected to a terminal end of the lower shaft portion 60 of the shaft assembly 42, on an end of the second portion 64. The lower universal joint 80 further includes a right angle cross member 86 that is connected to the output yoke member 82 and the input yoke member 84.

The cross member 86 enables pivotal movement to occur about orthogonal axes 110 and 112. The output yoke member 82 and the cross member 86 are pivotal relative to each other about the axis 110. The input yoke member 84 and the cross member 86 are pivotal relative to each other about the axis 112. The axis 110 extends perpendicular to the axis 112 and to an axis 114 about which the output yoke member 82 and the input shaft 30 (see FIG. 1) of the steering gear 26 and the output yoke member 82 are rotatable. The axis 112 extends perpendicular to the axis 66 about which the lower shaft portion 60 of the shaft assembly 42 is rotatable.

The middle universal joint 90 includes an output yoke member 92 that is fixedly connected to a terminal end of the lower shaft portion 60 of the shaft assembly 42 opposite the lower universal joint 80. The middle universal joint 90 also includes an input yoke member 94 that is fixedly connected to a terminal end of the upper shaft portion 50 of the shaft assembly 42 opposite the upper universal joint 70. The middle universal joint 90 further includes a right angle cross member 96 that is connected to the output yoke member 92 and the input yoke member 94.

The cross member 96 enables pivotal movement to occur about orthogonal axes 120 and 122. The output yoke member 92 and the cross member 96 are pivotal relative to each other about the axis 120. The input yoke member 94 and the cross member 96 are pivotal relative to each other about the axis 122. The axis 122 extends perpendicular to the axis 120 and to the axis 56 about which the upper shaft portion 50 of the shaft assembly 42 is rotatable. The lower shaft portion 60 of the shaft assembly 42 and the output yoke member 92 of the middle universal joint 90 are rotatable about the axis 66 about which the lower shaft portion 60 of the shaft assembly 42 is rotatable.

In the illustrated embodiment, the steering column 34 (FIG. 1) is fixedly connected to the body 16 so that the axis 104 about which the output shaft 36 and input yoke member 74 rotate remains stationary relative to the body 16. If, however, the steering column 34 was of the tilt type, the orientation of the axis 114 about which the input yoke member 74 rotates could be varied relative to the body 16 of the vehicle 10 upon adjustment of the position of the steering column 34 relative to the passenger compartment 22. In this instance, the upper universal joint 70 would help accommodate such tilting adjustment of the steering column 34.

The first and second portions 52 and 54 of the upper shaft portion 50 are configured to transmit rotational force while maintaining their variable length, telescoping relationship with each other. To achieve this, the first portion 52 has longitudinally extending flutes 150 that are slidably received in longitudinally extending flutes 152 formed in the second portion 54. Mating engagement between the flutes 150 in the first portion 52 and the flutes 152 in the second portion 54 prevents relative rotation between the first and second portions of the upper shaft portion 50 of the shaft assembly 42. Alternative means, such as providing the first and second portions 52 and 54 with keys and corresponding keyways or forming the first and second portions with mating polygonal cross-sectional configurations, could also be used to prevent relative rotation between the first and second portions.

The first and second portions 62 and 64 of the lower shaft portion 60 are configured to transmit rotational force while maintaining their variable length, telescoping relationship with each other. To achieve this, the first portion 62 has longitudinally extending flutes 160 that are slidably received in longitudinally extending flutes 162 formed in the second portion 64. Mating engagement between the flutes 160 in the first portion 62 and the flutes 162 in the second portion 64 prevents relative rotation between the first and second portions of the lower shaft portion 60 of the shaft assembly 42. Alternative means, such as providing the first and second portions 62 and 64 with keys and corresponding keyways or forming the first and second portions with mating polygonal cross-sectional configurations, could also be used to prevent relative rotation between the first and second portions.

According to the present invention, the apparatus 40 also includes a support assembly 200 for helping to support the shaft assembly 42 in the vehicle 10. The support assembly 200 includes a bracket 210, a bearing assembly 240 and a containment ring assembly 280. The bearing assembly 240 and the containment ring assembly 280 are connected to the bracket 210, which is connected to the vehicle 10. The bearing assembly 240 and the containment ring assembly 280 are thus connected to the vehicle 10 via the bracket 210.

As best shown in FIG. 2, the bracket 210 has a generally inverted U-shaped configuration with a generally rectangular cross-section. Those skilled in the art, however, will appreciate that the configuration of the bracket 210 may vary depending on a variety of factors, such as the architecture of the vehicle 10 and the orientation of the shaft assembly 42 in the vehicle. For example, the bracket 210 may have a shape different from the inverted, generally U-shaped configuration of FIGS. 1 and 2 so that the bracket may be accommodated in the space available in the vehicle 10. Also, the bracket 210 may have a different cross-section, such as round or polygonal. Furthermore, there may be more than one bracket, e.g., separate brackets for the bearing assembly 240 and containment ring assembly 280, or the brackets may be omitted, in which case the bearing assembly and containment ring assembly could be connected directly to the vehicle 10.

The bracket 210 includes a longitudinally extending base portion 212 and first and second leg portions 214 and 216, respectively, that extend transversely from opposite ends of the base portion. Referring to FIG. 1, the first leg portion 214 of the bracket 210 is connected to a portion 220 of the vehicle 10 by means 222, such as fasteners. In the illustrated embodiment, the portion 220 of the vehicle 10 comprises the body 16 of the vehicle. The first leg portion 214 may include apertures 224 through which the fasteners 222 may extend. The fasteners 222 rigidly connect the bracket 210, and thus the support assembly 200, to the portion 220 of the vehicle 10.

The bearing assembly 240 includes a base portion 242 and a support portion 244 that extends transversely from the base portion. The support portion 244 supports a housing portion 246 of the bearing assembly 240 opposite the base portion 242. The support portion 244 includes a fracture joint 248 that comprises a pair of V-shaped notches formed on opposite sides of the support portion adjacent or near the housing portion 246. The fracture joint 248 could have other configurations. For example, the fracture joint 248 could have an alternative shape, such as a square or rounded notch, or an alternative extent, such as extending around the entire periphery of the support portion 244.

The base portion 242 includes laterally extending flange portions 250 through which means 252, such as fasteners, may extend to connect the base portion to an L-bracket 254. The L-bracket 254 is connected to the second leg portion 216 of the bracket 210 by means 256, such as threaded fasteners. The bearing assembly 240 is thus connected to the bracket 210, which provides rigid support of the bearing assembly on the body 16 of the vehicle 10.

The housing portion 246 of the bearing assembly 240 supports a bearing 260, such as a roller bearing or ball bearing. The bearing 260 includes an outer ring 262 and an inner ring 264 that are arranged concentrically so as to define between them an annular race 266. The bearing 260 also includes a plurality of bearing elements 268, such as spherical balls, cylindrical rollers, or frusto-conical rollers. The bearing elements 268 are positioned in the race 266 and spaced about the race in an annular fashion.

The bearing 260 is connected to the housing portion 246 by known means, such as the housing portion being press-fitted onto the outer ring 262. Alternative means (not shown), such as forming the housing portion 246 as a pair of semi-circular halves that clamp onto the bearing 260, could also be used to connect the bearing to the housing portion. The position of the outer ring 262 is thus fixed relative to the housing portion 246. The inner ring 264 is supported by the bearing elements 268 for rotational movement relative to the outer ring 262, relative to the bearing assembly 240, and relative to the support assembly 200.

The containment ring assembly 280 includes a base portion 282 and a support portion 284 that extends transversely from the base portion. The support portion 284 supports a containment ring 286 of the containment ring assembly 280 opposite the base portion 282. The base portion 282 includes laterally extending flange portions 290 through which means 292, such as fasteners, may extend to connect the base portion to the base portion 212 of the bracket 210 by means 296, such as threaded fasteners. The containment ring assembly 280 is thus connected to the bracket 210, which provides rigid support of the containment ring assembly on the body 16 of the vehicle 10.

The containment ring 286 has a split-ring configuration and includes a pair of semi-circular ring portions 300 and 302 that are connected to each other by means 304, such as threaded fasteners, that extend through adjacent flange portions 306 of the ring portions 300 and 302. One of the ring portions, i.e., the portion 300, may be formed as a single piece with the support portion 284. It will be appreciated, however, that the containment ring 286 could have alternative configurations, such as forming the ring as a single continuous piece with the support portion 284.

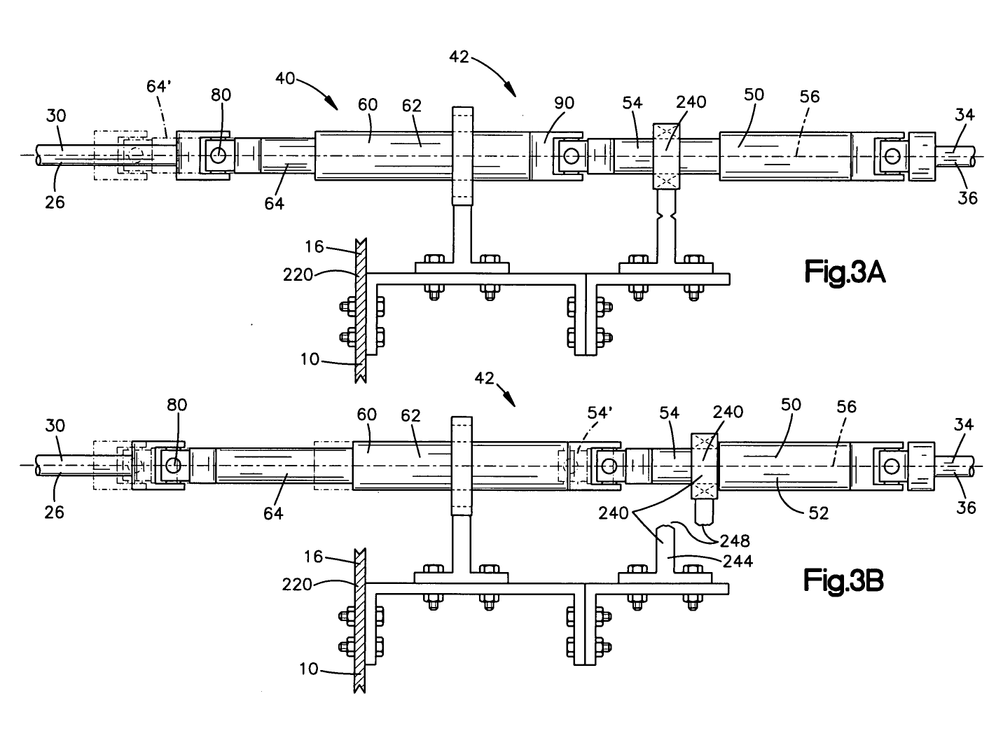

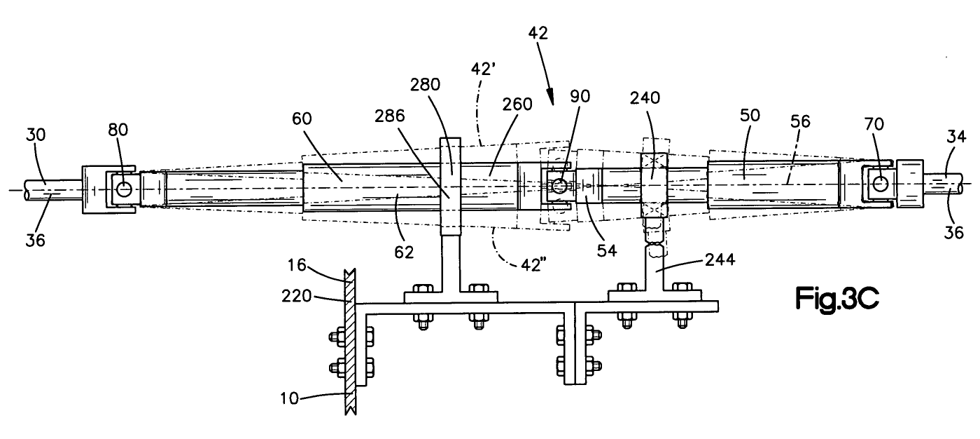

Referring to FIGS. 2 and 3, in the assembled condition of the apparatus 40, the bracket 210 is rigidly connected to the portion 220 of the vehicle body 16 by the fasteners 222. The L-bracket 254 is connected to the second leg portion 216 of the bracket 210 by the fasteners 256. The bearing assembly 240 is connected to the upper shaft portion 50, i.e., the second portion 54, by known means, such as press-fitting the inner ring 264 onto the upper shaft portion. The bearing assembly 240 is also rigidly connected to the L-bracket 254 by the fasteners 252. The ring portions 300 and 302 of the containment ring 286 are positioned to encircle the lower shaft portion 60 of the shaft assembly 42 and connected by the fasteners 304. The containment ring assembly 280 is rigidly connected to the bracket 210 by the fasteners 292.

Upon rotation of the steering wheel 28, the first portion 52 of the upper shaft portion 50 rotates with the output shaft 36 of the steering column 34. This results in longitudinally extending side surfaces of the flutes 150 in the first portion 52 being pressed against longitudinally extending side surfaces of the flutes 152 in the second portion 54. The flutes 150 and 152 transmit rotational force from the first portion 52 to the second portion 54. As a result, the upper shaft portion 50 of the shaft assembly 42 rotates with the steering wheel.

Rotation of the upper shaft portion 50 of the shaft assembly 42 imparts a rotational force on the middle universal joint 80. The first portion 62 of the lower shaft portion 60 rotates with the middle universal joint 80. This results in longitudinally extending side surfaces of the flutes 160 in the first portion 62 being pressed against longitudinally extending side surfaces of the flutes 162 in the second portion 64. The flutes 160 and 162 thus transmit rotational force from the first portion 62 to the second portion 64. As a result, the lower shaft portion 60 of the shaft assembly 42 rotates with the upper shaft portion 50 of the shaft assembly.

The shaft assembly 42 is thus configured to transmit rotational forces from the steering wheel 28 to the steering gear 26. More particularly, rotational forces are transmitted from the steering wheel 28 to the steering column 34, from the steering column to the upper shaft portion 52 of the shaft assembly 42 via the upper universal joint 70, from the upper shaft portion to the lower shaft portion 54 via the middle universal joint 80, and from the lower shaft portion to the steering gear 26 via the lower universal joint 90.

In the assembled condition, the bearing assembly 240 permits rotation of the upper shaft portion 50 about the axis 56 and prevents axial movement of the second shaft portion 54 along the axis 56. The support assembly 200 thus helps fix the position of the axis 56 of the upper portion 50 of the shaft assembly 42 relative to the vehicle body 16. This helps limit movement of the axis 66 of the lower portion 60 of the shaft assembly 42 to movements resulting from relative movement between the steering gear 26, frame 12, and body 16 of the vehicle 10. Under normal driving and vehicle conditions, for a given position of the steering gear 26, frame 12, and body 16, the axis 66 of the lower portion 60 will have a substantially fixed position. This helps give a tight feel to the vehicle steering afforded by the shaft assembly 42.

The variable length or telescoping configuration of the lower shaft portion 60 of the shaft assembly 42 enables the shaft assembly to accommodate relative movement between the steering gear 26, frame 12, and body 16 of the vehicle 10. The length of the lower shaft portion 60 varies as the position of the body 16 relative to the frame 12 changes, as facilitated by the resilient connections 18 between the body and frame.

The length of the lower shaft portion 60 also varies as the position of the steering gear 26 changes relative to the body 16 and frame 12 of the vehicle 10. This helps dampen shocks and vibrations that may otherwise be transmitted through the shaft assembly 42 and felt by an operator (not shown) through the steering wheel 28. For example, road vibrations and bumps that may routinely experienced while operating the vehicle 10 on a roadway may be dampened by the lower shaft portion 60.

If the lower shaft portion 60 loses its ability to telescope, the condition of the shaft assembly 42 may become jeopardized. This may occur, for example, where the steering gear 26 bottoms out, i.e., moves an excessively large distance relative to the body 26, such as when a large bump, pothole, or debris is encountered. This may also occur when the telescoping function of the first and second portions 62 and 64 undergoes failure, for example, where relative movement of the first and second portions 62 and 64 ceases, for example, due to fretting, corrosion, or friction. The condition of the shaft assembly 42 is jeopardized because the lower shaft portion 60 is no longer able to accommodate the change in distance between the steering gear 26 and the frame 12. In this instance, components of the shaft assembly 42, such as the lower shaft portion 60, and universal joints 70, 80, and 90 may fracture, break, or otherwise fail.

According to the present invention, the fracture joints 248 on the bearing assembly 240 are configured to rupture if the lower shaft portion 60 fails or bottoms out, as described above. This releases the upper shaft portion 50 of the shaft assembly 42 to telescope and thereby absorb relative movement between the steering gear 26, the frame 12, and body 16. As a result, further damage and failure of the shaft assembly 42 may be avoided and the ability to steer the vehicle via the shaft assembly may be maintained.

When the fracture joints 248 rupture, the bearing assembly 240 no longer limits movement of the upper and lower shaft portions 50 and 60 transverse to their respective axes 56 and 66. Instead, the containment ring assembly 280 limits movement of the upper and lower shaft portions 50 and 60 transverse to their respective axes 56 and 66. The range of movement afforded by the containment ring assembly 280 is determined by the size of the annular clearance between the lower shaft portion 60 and the containment ring 286. Thus, upon failure of the lower portion 60 of the shaft assembly 42, the steering feel is transformed from the tight feel provided by the bearing assembly 240 to a loose or sloppy feel provided by the containment ring assembly 280. This will provide notice to an operator of the vehicle 10 that there is a problem with the shaft assembly 42 while maintaining the steering ability of the vehicle 10.

Operation of the apparatus 40 is illustrated schematically in FIGS. 3A-3C. Referring to FIG. 3A, under normal operating conditions of the apparatus 40 and vehicle 10, the lower shaft portion 60 of the shaft assembly 42 telescopes between an un-shortened or extended condition, indicated in solid lines, and a shortened or compressed condition, indicated in dashed lines. In the shortened condition, the second portion 64 telescopes into the first portion 62, as shown in dashed lines at 64′. The lower shaft portion 60 telescopes between these conditions to accommodate relative movement between the body 16 of the vehicle 10, frame 12 of the vehicle, and steering gear 26 of the vehicle, as described above.

When the apparatus 40 is in the condition of FIG. 3A, the bearing assembly 240 helps maintain the position of the axis 56 of the upper shaft portion 50 relative to the portion 220 of the vehicle 12, e.g., the body 16. In this condition, the shaft assembly 42 helps maintain a tight steering feel because there is little room for play or slop in the linkage between the steering column 34 and the steering gear 26 (see FIG. 1). This is because, as shown in FIG. 3A, the end of the second portion 54 of the upper shaft assembly 50 where the middle U-joint 90 is connected has a substantially fixed position relative to the portion 220 of the vehicle 10. Thus, the movable portion of the linkage provided by the shaft assembly 42 is the lower shaft portion 60 in combination with the lower and middle U-joints 80 and 90. Thus, for any relative position of the vehicle portion 220 and the steering gear 26, the position of the lower shaft portion 60, lower U-joint 80, and middle U-joint 90 is substantially fixed.

Referring to FIG. 3B, when a problem is encountered at the lower shaft portion 60, such as the first and second portions 62 and 64 locking-up or reaching the end of travel, the support portion 244 of the bearing assembly 240 ruptures or breaks at the fracture joint 248. This allows the upper shaft portion 50 to telescope, i.e., the second portion 54 telescopes into the first portion 52. When this occurs, the second portion 54 travels from the extended condition illustrated in dashed lines at 54′ to the compressed condition shown in solid lines. The telescoping upper shaft portion 50 permits axial movement of the entire lower shaft portion 60. As a result, in the condition illustrated in FIG. 3B, the upper shaft portion 50 helps accommodate relative movement between the body 16, frame 12, and steering gear 26. It will be appreciated that, in the condition of the shaft assembly 42 illustrated in FIG. 3B, the lower shaft portion 60, if operable, may also help accommodate relative movement between the body 16, frame 12, and steering gear 26.

Referring to FIG. 3C, once the support portion 244 of the bearing assembly 240 breaks, the axis 56 no longer has a fixed position and is thus movable relative to the vehicle portion 220. Movement of the axis 56 relative to the portion 220 is contained by the containment ring assembly 280, particularly the containment ring 286, which encircles the lower shaft portion 60. For the relative position of the shaft 30 of the steering gear 26 and the shaft 36 of the steering column 34 shown in FIG. 3C, the containment ring assembly 280 limits movement of the shaft assembly 42 to the extremes identified in dashed lines at 42′ and 42″ in FIG. 3C. In particular, the upper shaft portion 50 pivots relative to the steering column 34 about the upper U-joint 70, the lower shaft portion 60 pivots relative to the steering gear 26 about the lower U-joint 80, and the upper and lower shaft portions pivot relative to each other about the middle U-joint 90.

In the condition shown in FIG. 3C, there is room for play or slop in the linkage between the steering column 34 and the steering gear 26. The shaft assembly 42 thus provides a loose steering feel, which indicates to an operator of the vehicle 10 that there is a problem with the shaft assembly. As shown in FIG. 3C, the second portion 54 of the upper shaft assembly 50 and the first portion 62 of the lower shaft assembly, being connected with the middle U-joint 90, are free to move relative to the portion 220 of the vehicle 10. Thus, for any relative position of the vehicle portion 220 and the steering gear 26, there are many positional combinations of the upper shaft portion 50, lower shaft portion 60, upper U-joint 70, lower U-joint 80, and middle U-joint 90 that will accommodate the relative position. These combinations provide a loose or sloppy steering feel that will provide the desired indication to a vehicle operator that there is a problem with the shaft assembly. Upon receiving this indication, the operator may steer the vehicle to a safe halt in order to seek appropriate vehicle maintenance.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for transmitting force between a steering wheel and a steering gear that is operable to turn steerable wheels of a vehicle, said apparatus comprising:
a shaft assembly including a pair of telescoping shaft portions rotatable about a common axis to effect vehicle steering;
a bearing supporting at least one of said pair of shaft portions for rotation about said common axis;
a support for said bearing, said support being breakable when said telescoping shaft portions are blocked from telescoping movement; and
a containment structure that permits limited movement of said telescoping shaft portions transverse to said common axis in the event that said support breaks.

2. The apparatus recited in claim 1, wherein said support for said bearing is secured to the vehicle and the force for breaking said support is transmitted to the support for the bearing through an inner ring of the bearing, rotatable bearing elements of the bearing, and an outer ring of the bearing.

3. The apparatus recited in claim 1, wherein said bearing and said support for said bearing form a bearing assembly connectable to a portion of the vehicle.

4. The apparatus recited in claim 3, wherein said containment structure is connectable to the portion of the vehicle, said containment structure comprising a containment ring encircling a portion of said shaft assembly and forming an annular clearance with said portion of said shaft assembly.

5. The apparatus recited in claim 3, wherein the portion of the vehicle is a cab of the vehicle, the cab and the steering gear being movable relative to each other.

6. The apparatus recited in claim 3, wherein said containment ring permits movement of said telescoping shaft portions transverse to said common axis and relative to the portion of the vehicle.

7. The apparatus recited in claim 1, wherein said support for said bearing comprises a breakable portion breakable in the event of a predetermined axial load being exerted on said support by said shaft assembly.

8. The apparatus recited in claim 1, further comprising a bracket connectable to the support for said bearing and to said containment structure, said bracket being connectable to the vehicle to connect the support for said bearing and said containment structure to the vehicle.

9. The apparatus recited in claim 1, further comprising a second pair of telescoping shaft portions, said support blocking relative axial movement between said second pair of telescoping shaft portions prior to being broken, said support when broken releasing said second pair of telescoping shaft portions for relative axial movement.

10. The apparatus recited in claim 9, further comprising:
an upper universal joint connectable with the steering wheel, a first end of said first pair of telescoping shaft portions being connected to said upper universal joint;
a lower universal joint connectable with the steering gear, a first end of said second pair of telescoping shaft portions being connected to said lower universal joint; and
a middle universal joint connecting a second end of said first pair of telescoping shaft portions to a second end of said second pair of telescoping shaft portions.

11. The apparatus recited in claim 1, wherein the telescoping shaft portions have a length that varies to permit movement of said steering gear, a frame of the vehicle, and a body of the vehicle relative to each other.

12. An apparatus for transmitting force between a steering wheel and a steering gear that is operable to turn steerable wheels of a vehicle, said apparatus comprising:
a shaft assembly comprising a first shaft portion having a telescoping length and a second shaft portion having a telescoping length, said first and second shaft portions each having a longitudinal axis, said shaft assembly having a first end operatively connected to the steering gear and an opposite second end operatively connected to the steering wheel;
a bearing assembly connected to a portion of the vehicle, said bearing assembly supporting said first shaft portion for rotation about its longitudinal axis; and
a containment structure for limiting movement of the longitudinal axis of said first shaft portion relative to the portion of the vehicle upon breakage of said bearing assembly.

13. The apparatus recited in claim 12, wherein said bearing assembly comprises a breakable portion breakable when said first shaft portion exerts a predetermined axial load on said bearing assembly, said breakable portion when broken permitting the longitudinal axis of first shaft portion to move relative to the portion of the vehicle.

14. The apparatus recited in claim 12, wherein said bearing assembly comprises a breakable portion breakable when said first shaft portion exerts a predetermined axial load on said bearing assembly, the length of said second shaft portion being variable to accommodate movement of the steering gear relative to the portion of the vehicle when said breakable portion is broken.
